(19) United States
(12) Patent Application Publication
(10) Pub. No.: US 2025/0100150 A1
(43) Pub. Date: Mar. 27, 2025

(54) AUTOMATED TOOL CENTER POINT CALIBRATION

(71) Applicant: BACA SYSTEMS, LLC, Orion Township, MI (US)

(72) Inventors: Whitney Moon, Richmond, VA (US); Ryan Fossett, Hazel Park, MI (US); Tyler Rogers, Lake Orion, MI (US); Ryan Tewell, Oakland Twp, MI (US); Charles Allen Abrams, St. Clair Shores, MI (US)

(21) Appl. No.: 18/889,670

(22) Filed: Sep. 19, 2024

Related U.S. Application Data
(60) Provisional application No. 63/585,303, filed on Sep. 26, 2023.

(51) Int. Cl. B25J 9/16; B25J 11/00

(52) U.S. Cl. CPC B25J 9/1692; B25J 9/1664; B25J 11/0055

(57) ABSTRACT

A calibration system and associated methods of calibration are disclosed. The system may include one or more sensors operable to determine the position and/or orientation of a tool. The system may be operable to move the tool along a path. An orientation of the tool may differ along the path. The sensor may measure the tool position and/or orientation at one or more positions along the path.

### CROSS-REFERENCE TO RELATED APPLICATION

This application claims the benefit of U.S. Provisional Application No. 63/585,303, filed on Sep. 26, 2023, which is incorporated herein by reference.

### BACKGROUND

Robots and other automated devices have proven useful for a variety of purposes. Some examples include manufacturing and assembly processes. Some robots have been used for cutting slabs of material, such as stone. Accuracy of the cuts may depend in part on the tool center point (TCP) of the cutting tool. Some techniques use a dial indicator or contact probe to calibrate the TCP.

### SUMMARY

A calibration system may include a sensor operable to determine a distance of a tool relative to the sensor. A controller may be coupled to the sensor. The controller may be operable to determine a tool center point of the tool based on the determined distance.

In any implementations, the tool may include a saw blade.

In any implementations, the tool may include a fluid jet cutter.

In any implementations, the tool may include a calibration tool representative of another tool.

In any implementations, the controller may be operable to cause the tool to move relative to a predefined pattern. The distance may be established relative to the predefined pattern.

A method of calibrating an automated device may include securing a tool to an automated device. The method may include moving the tool based on a predefined pattern. The method may include determining one or more distances of the tool relative to the predefined pattern. The method may include determining a tool center point of the tool based on the one or more determined distances.

In any implementations, the moving step may include adjusting a position and/or orientation of the tool according to the predefined pattern.

The present disclosure may include any one or more of the individual features disclosed above and/or below alone or in any combination thereof.

The various features and advantages of at least one disclosed example embodiment will become apparent to those skilled in the art from the following detailed description. The drawings that accompany the detailed description can be briefly described as follows.

### BRIEF DESCRIPTION OF THE DRAWINGS

FIG. 1 discloses a system including an automated device positioned relative to a workpiece.

FIG. 2 disclose a calibration system including a sensor positioned relative to a tool of the automated device.

FIG. 3 discloses a method of calibration in a flowchart.

FIG. 4 discloses a tool positioned relative to a field of view of the sensor of FIG. 2.

FIG. 5 discloses a side view of the tool of FIG. 4.

FIG. 6 discloses an end view of the tool of FIG. 4.

FIG. 7 discloses an oblique view of the tool of FIG. 4.

FIGS. 8-12 disclose plan views of various positions of the tool relative to the field of view of the sensor.

FIGS. 13-14 disclose another implementation of a calibration system.

### DETAILED DESCRIPTION

The disclosed calibration systems and methods may be utilized to calibrate or otherwise determine a tool center point (TCP) of one or more tools coupled to an automated device, such as a robot or gantry. The tool may be an end of arm tool (EOAT) that may be coupled to the automated device. The tool may include a cutting instrument such as a saw blade or fluid jet cutter (e.g., waterjet device) useful for removing material from a workpiece, such as a slab. The slab may be natural or manufactured stone. The TCP may be associated with a center of rotation of the saw blade or a tip portion of a mixing tube of the fluid jet cutter. The calibration techniques disclosed herein may be utilized to account for different manufacturing and/or assembly tolerances associated with the automated device and/or tools. The automated calibration process may remove the need for personnel to manually measure the saw blade, mixing tube of the fluid jet cutter, and/or other tools.

The calibration system may be operable to cause the robot or other automated device to manipulate or otherwise position the tool in a detection path of one or more sensors, which may include a field of view (e.g., front) of the respective sensor. The sensor may be a laser or other device. The sensor may be operable to determine a distance between surface(s) of the tool and the sensor. The calibration system may be incorporated into a control device of the automated device or may be a standalone device operable to interface with the automated device. The calibration system may be operable to calculate a calibration offset. The calibration system may be operable to apply the calculated calibration offset to the (e.g., baseline) TCP values of the automated device. Utilizing the automated calibration techniques disclosed herein, the time to calibrate the system may be reduced from approximately one hour to less than approximately five minutes.

Various techniques may be utilized to perform the calibration. In implementations, the calibration system may be operable to cause the robot or other automated device to manipulate or otherwise position the tool in front of, or otherwise in the field of view of, the sensor(s). In implementations, the tool may be a rotatable saw blade. Each sensor may be operable to communicate one or more signals to the calibration system. The signals may be associated with a distance between the surface(s) of the tool and the sensor. The signals may be digital and/or analog. The calibration system may be operable to determine one or more tool coordinate systems (e.g., frames) and their respective locations relative to one or more degrees of freedom based on the measured distance(s) between the sensor and the specific point(s) on the tool. In implementations, the degrees of freedom may include 6 or more degrees of freedom (e.g., X, Y, Z, A, B, C). X, Y, Z may be associated with axes of a coordinate system. A, B, C may be associated with yaw, pitch and roll. That is, rotation about the Z, Y, and X axes respectively. The calibration system may be operable to determine the TCP of the tool based on the tool frames and respective locations.

Various techniques may be utilized to determine the TCP of a mixing tube and/or other portion of the fluid jet cutter. In implementations, an operator may replace the mixing tube of the waterjet device with a (e.g., process-specific, target) calibration tool (e.g., block) of known dimension. The calibration tool may be attached or otherwise secured to a head of the fluid jet cutter. The operator may remove a cover from the saw blade to avoid obstructing the field of view of the sensor.

The operator may interact with the calibration system, robot and/or other automated device to initiate a calibration sequence. The calibration system may cause the robot or other automated device to move or otherwise position the saw blade in front of, or otherwise in the field of view, of the sensor(s). In implementations, the calibration system may be operable to cause the robot or other automated device to move the saw blade or other tool in a predefined pattern. The predefined pattern may include a set of position and/or orientations of the saw blade or other tool. The calibration system may be operable to cause the sensor(s) to generate distance readings between the (e.g., face) of the sensor and specific point(s) on the blade or other tool at one or more, or each position and/or orientation of the tool associated with the predefined pattern. The calibration system may be operable to determine a diameter and/or plane of the saw blade based on the determined distances.

The calibration system may be operable to determine a center point of the saw blade or other tool based on a combination of motion of the saw blade in the field of view of the sensor(s) and the determined distances. The robot or other automated device may move the saw blade in the field of view of the sensor(s). The calibration system may be operable to determine an (e.g., bottom) edge of the saw blade based on the determined center point.

The calibration system may be operable to cause the robot or other automated device to rotate or otherwise move the head of the fluid jet cutter into position such that the calibration tool may be positioned in front of, or otherwise in the field of view of, the sensor(s). The sensor(s) may be operable to determine the distance between the calibration tool and the respective sensor(s). The calibration system may be operable to determine the location and/or angle of the calibration device based on the measured distance(s), which may be associated with the location and/or angle of the mixing tube when attached or otherwise secured to the head of the fluid cutting device.

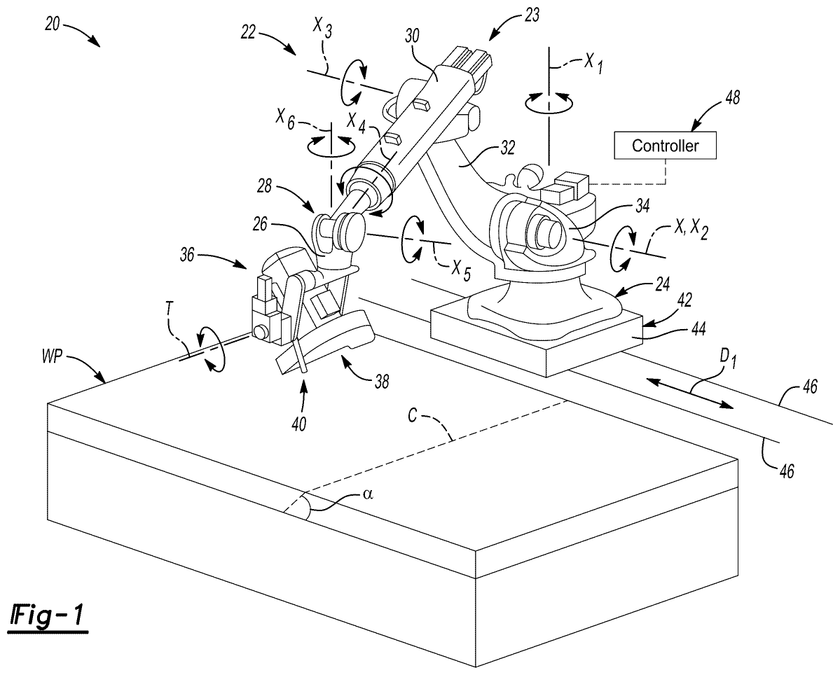

Referring to FIG. 1, a (e.g., automated) system 20 including an automated device 22 for positioning one or more tools relative to a workpiece is disclosed. The system 20 may be a robotic system, and the automated device 22 may be a robot that may articulate relative to one or more degrees of freedom. Other automated devices and systems may benefit from the teachings disclosed herein, such as a gantry device.

The robot 22 may include a base 24 near one end and a wrist flange 26 near an opposite end. The robot 22 may be an articulated robot that may have a plurality of portions in series between the wrist flange 26 and the base 24. The robot 22 may include an arm 23. The arm 23 may be operable to articulate relative to the base 24. The arm 23 may include one or more arm portions that may articulate relative to each other, such as arm portions 30, 32, 34. A wrist 28, which includes the flange 26, may be near one end of the arm portion 30. The arm portion 32 may be situated between the arm portions 30, 34. The arm portion 34 may be situated adjacent to the base 24.

The arm portions 28, 30, 32, 34 may be moveable about respective axes X relative to each other and/or the base 24. The axes X may include axes X₁ to X₆. In the implementation of FIG. 1, the robot 22 may include six axes (e.g., X₁ to X₆), and the robot 22 may be referred to as a six-axis articulated robot. The arm portion 32 may be moveable relative to the portion 34 about the axis X₁. The arm portion 34 may be moveable relative to the base 24 about the axis X₂. The arm portion 30 may be moveable about the axis X₃. The wrist flange 26 may be rotatable about the axis X₄. The wrist 28 may be moveable about the axis X₅ and/or axis X₆. Although the robot 22 is disclosed as having six axes, it should be understood that the teachings disclosed herein may be utilized with automated devices having fewer or more than six axes, such as five axes or even a single axis.

The arm 23 may be configured to mount one or more end of arm tools (EOAT) 36. Various end of arm tools may be utilized, such as a saw, fluid jet cutter and/or other tools. The tool 36 may be secured to the arm 23 at an interface, which may be established along the wrist flange 26. In implementations, two or more end of arm tools 36 may be secured to the wrist flange 26, including any of the tools disclosed herein. Each tool 36 may be selectively moveable relative to the wrist flange 26 about a tool axis T. The tools 36 may be the same or may differ from each other. The tools 36 may include various cutting tools such as saw blade(s) 38 and/or fluid jet cutter(s) 40. In implementations, the fluid jet cutter 40 may be a waterjet device operable to deliver a relatively high-pressure fluid stream to surfaces of a workpiece. The fluid stream may include water carrying particulates such as sand. In implementations, the fluid jet cutter 40 may be omitted. The tools 36 may include at least two saw blades 38 secured to the wrist flange 26. A TCP of each of the saw blades 38 may be calibrated utilizing any of the techniques disclosed herein. Other tools 36 may include a spindle adapted to (e.g., releasably) secure another tool (e.g., router). A TCP of the spindle may be calibrated utilizing any of the techniques disclosed herein, such as the techniques associated with the fluid jet cutter 40.

The base 24 of the robot 22 may be secured to a (e.g., rotary) base support 42. The base support 42 may be selectively moveable to change a position and/or orientation of the base 24. In implementations, the base support 42 may be operable to rotate the robot 22, including the base 24, about an axis (e.g., axis X₂). The base support 42 may include a platform 44. The platform 44 may be moveable along rails 46 to move the base 24 linearly in a direction D₁ along a path.

A controller 48 may include one or more computing devices, such as one or more processors and associated memory. The controller may be programmed or otherwise operable to control movement of the robot 22 and the tool 36 to accomplish a desired operation. The controller 48 may be operable to cause respective motors (e.g., servos) associated with the joints (or axes X) of the robot 22 to operate in a manner that may control the positions and/or orientation of the portions 28, 30, 32, 34 and movement of those portions 28, 30, 32, 34 about the robot axes X. The controller 48 may be operable to control operation of a motor associated with the tool 36 to selective adjust the position and/or orientation of the saw blade 38 and/or fluid jet cutter 40 relative to the wrist flange 26.

The system 20 in FIG. 1 may be arranged to cut or otherwise dimension a workpiece WP. The workpiece WP may be a large slab of material, such as natural or manufactured stone. The system 20 may be arranged to make at least one cut C in the workpiece WP at an oblique angle α to a primary face of the workpiece WP. The oblique angle α may be greater than 0° and/or may be less than 90° relative to the primary face of the workpiece WP. The primary face of the workpiece WP may have a surface area that may be significantly larger than edges or sides of the workpiece WP. The primary face of the workpiece WP may be planar, but a pure or true plane is not required for defining an oblique angle α relative to that face of the workpiece WP. The term “planar” as used herein should not be construed in a strict sense that requires a truly flat or planar surface.

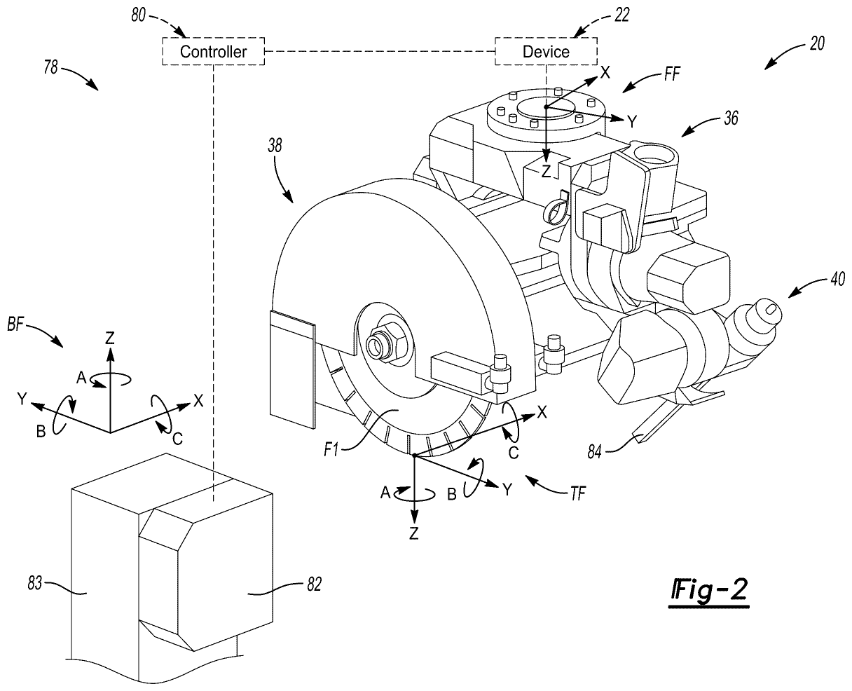

Referring to FIG. 2, with continuing reference to FIG. 1, the system 20 may include a calibration system (e.g., assembly) 78. The calibration system 78 may be operable to determine a position and/or geometry of the tool 36, such as a tool center point (TCP) of the tool 36. The determined TCP may be utilized to calibrate the automated device 22.

The calibration system 78 may include a controller 80 and one or more sensors 82. The controller 80 may include one or more computing devices, such as one or more processors and associated memory. The controller 80 may be programmed or otherwise operable to perform any of the functionality disclosed herein. In implementations, the controller 80 may be incorporated into the controller 48 or may be a standalone device that may be operable to communicate with the controller 48 (FIG. 1). Various sensors may be utilized, including any of the sensors disclosed herein. The sensors may include non-contacting (e.g., optical or laser) and/or contacting (e.g., touch probe) sensor configurations. In implementations, the sensor 82 may be a laser device, such as a free-mounted complementary metal-oxide semiconductor (CMOS) laser. The sensor 82 may be secured to a base 83. The sensor 82 may be associated with a base coordinate system (e.g., frame) BF. The tool 36 and/or portions thereof such as the saw blade 38 may be associated with a tool coordinate system (e.g., frame) TF. The tool coordinate system TF may be established relative to a flange coordinate system (e.g., frame) FF associated with the wrist flange 26. A position and/or orientation of the tool frame TF and/or base frame BF may differ from the flange frame FF. A world reference system may be associated with a work cell in which the robot 22 may be situated. The controller 80 may be configured to reference the world reference system. In implementations, the controller 80 may be operable to reference a position of the robot 22 in the world system, including the flange frame FF.

The calibration system 78 may be operable to cause the robot or other automated device 22 to manipulate or otherwise position the tool 36 in front of, or otherwise in the field of view of, the sensor(s) 82. The controller 80 may be operable to communicate with the sensor(s) 82. Each sensor 82 may be operable to communicate one or more signals to the controller 80 and/or other portions of the calibration system 78. The signals may be associated with a distance between the between surface(s) of the tool 36 and the sensor 82, including surfaces associated with the saw blade 38, fluid jet cutter 40 and/or a representative component. A position of the sensor 82 relative to the base 24 (FIG. 1) may be known or unknown. The position of the sensor 82 relative to the tool 36 may be unknown prior to performing a calibration sequence, including the TCP of the saw blade 38 and/or fluid jet cutter 40.

The controller 80 may be operable to cause the device 22 to move the tool 36 along a predefined pattern. The predefined pattern may include an orientation of the tool 36 at one or more positions along a path. An orientation of the tool 36 may differ along the path. The controller 80 may cause the tool 36 to be placed in the different positions and/or orientations according to the predefined pattern. The sensor 82 may be operable to measure the position and/or orientation of the tool 36 at one or more positions along the path. The controller 80 may be operable to determine a coordinate system of the sensor(s) 82 in a cell associated with the device 22. The controller 80 may interact with the sensor 82 to refine or otherwise determine a nominal TCP of the mounted tool 36, which may account for manufacturing and assembly tolerances. Calibrating the system 20 utilizing the techniques disclosed herein may achieve highly accurate cutting operations.

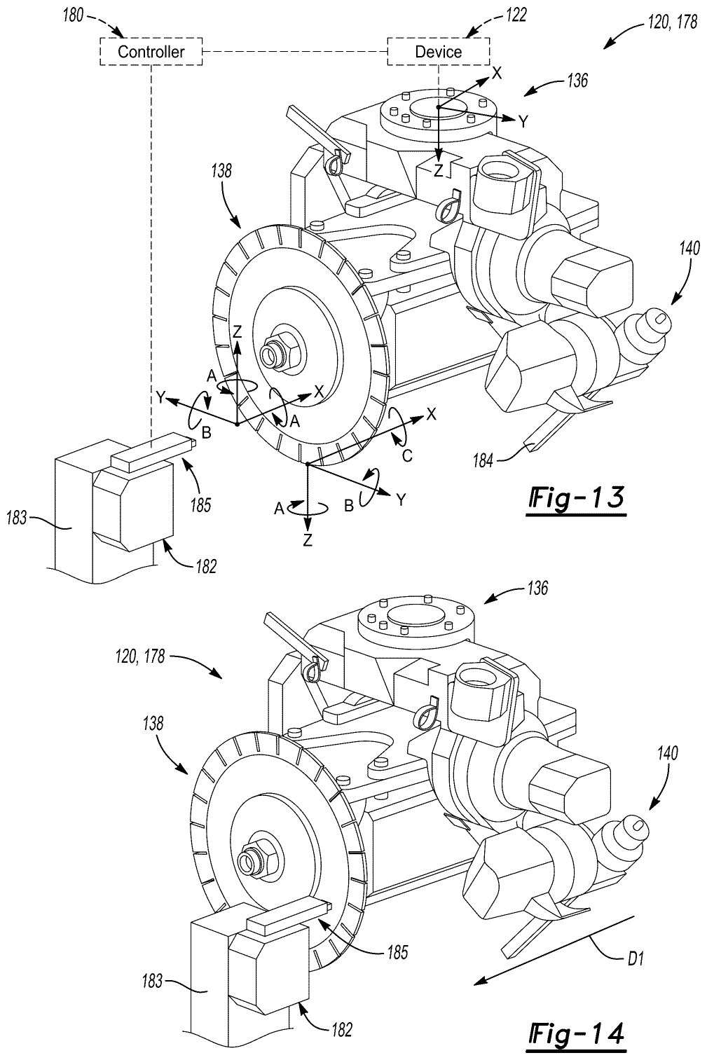

FIG. 3 discloses a method of calibrating a system in a flowchart 90. The method may be utilized to calibrate any of the systems disclosed herein, such as the system 20 (e.g., FIG. 2) and/or system 120 (e.g., FIG. 13). Fewer or additional steps than are recited below could be performed within the scope of this disclosure, and the recited order of steps is not intended to limit this disclosure. It should be understood that the controller 80/180 (e.g., FIGS. 2 and 13) and any of associated modules may be programmed or otherwise configured to perform any of the features of the method 90. Reference is made to the system 20 for illustrative purposes.

Referring to FIGS. 1 and 3, at step 90A an end of arm tool (EAOT) 36 may be mounted to the automated device 22, such as a robot. Step 90A may include securing one or more cutting devices to the tool 36, such as a saw blade 38 and/or fluid jet cutter 40. In implementations, a calibration tool (e.g., block) 84 may be coupled to the tool 36. The calibration tool 84 may be representative of a geometry a fluid stream of the fluid jet cutter 40. The calibration tool 84 may be attached or otherwise secured to a head of the fluid jet cutter 40.

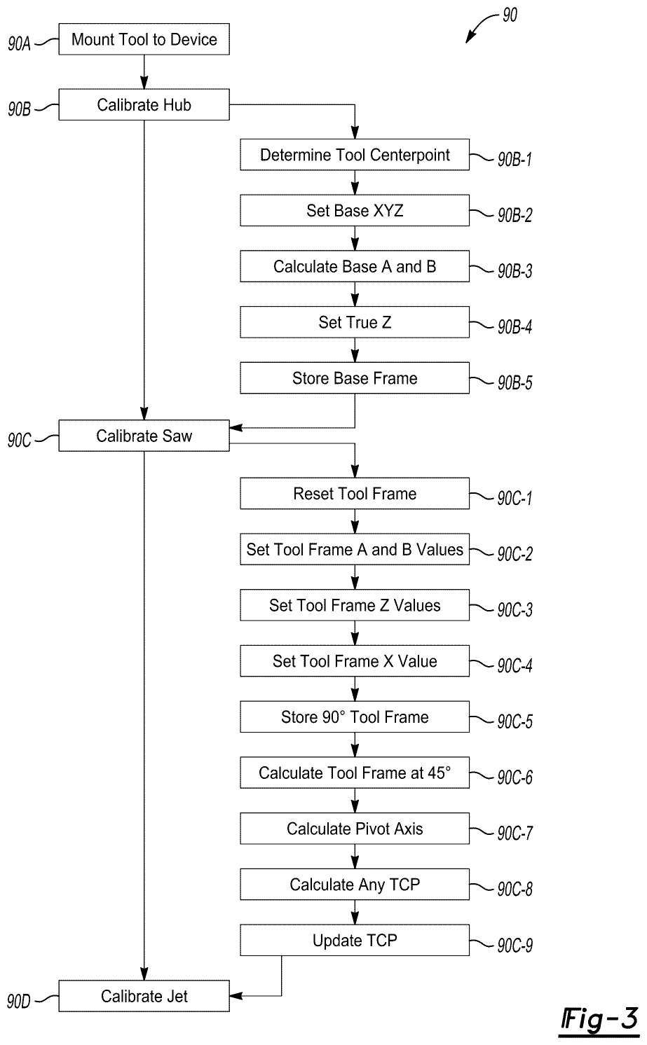

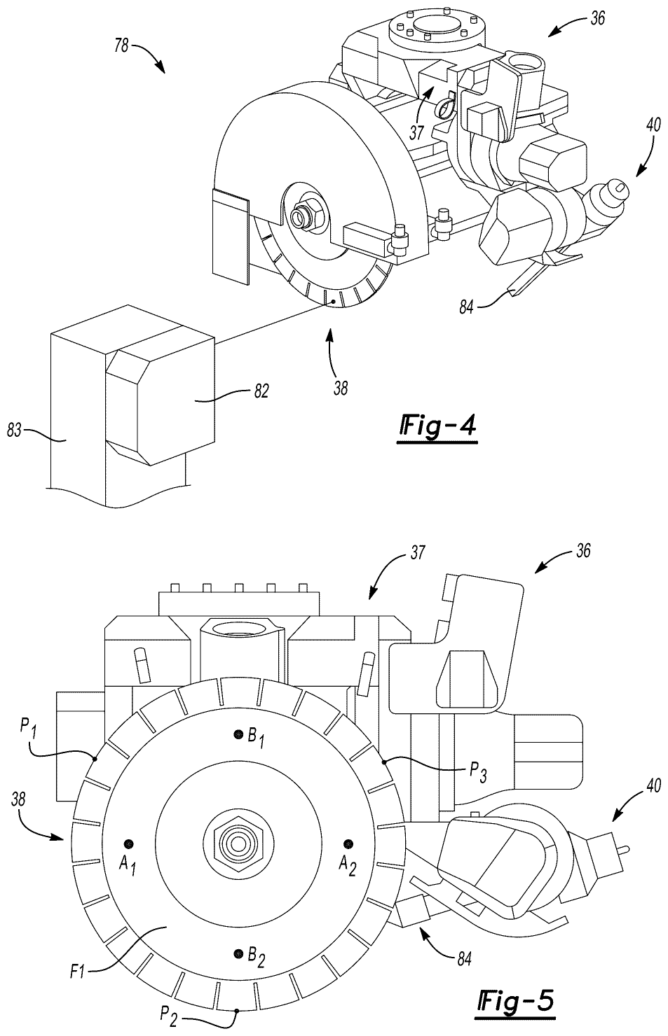

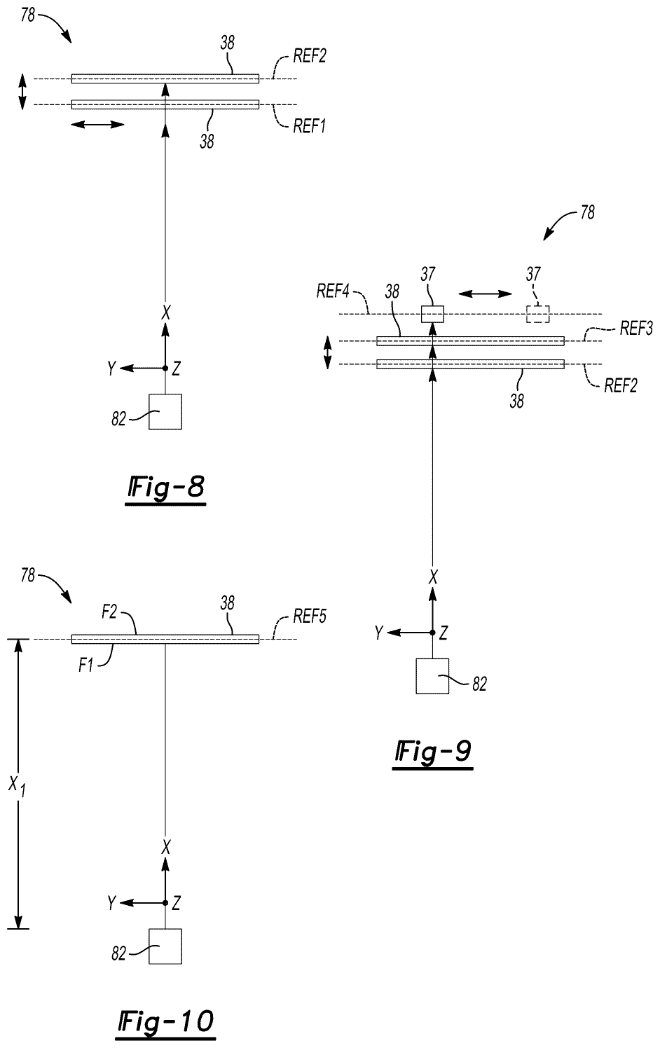

Referring to FIGS. 4 and 8-9, with continuing reference to FIGS. 1 and 3, at step 90B a position of a hub of the system 20 may be calibrated. Step 90B may include establishing a coordinate system (e.g., base frame BF of FIG. 2) that may be utilized for subsequent (e.g., all) calibration processes. The base frame BF may establish a global coordinate system. The controller 80 may be operable to determine, using the sensor 82, an amount and/or direction of movement of the tool 38 and/or associated tool center point TCP relative to the base frame BF, including during and/or subsequent to calibration. The sensor 82 may establish the hub (e.g., base). Step 90B may include determining a center point of the saw blade 38 at step 90B-1. Nominal (e.g., CAD) geometry may be utilized as a starting point. In implementations, the flange frame FF may be referenced to position the saw blade 38 in the field of view of the sensor 82. The saw blade 38 may be positioned relative to the sensor 82 to identify an origin of the saw blade 38. The sensor 82 may be utilized to detect an edge of the saw blade 38 in one or more positions. In implementations, the sensor 82 may be utilized to detect an edge of the saw blade 38 in three positions P1-P3 (FIG. 5) that may be spaced approximately 120 degrees apart (e.g., 2 o'clock, 6 o'clock, and 10 o'clock) as the saw blade 38 moves relative to the predefined pattern. The saw blade 38 may be moved along a first reference plane REF1 to each of the positions (FIG. 8). For the purposes of this disclosure, the terms “substantially,” “approximately” and “about” mean±5 percent of the stated value or relationship unless otherwise indicated.

Step 90B may include setting the base positions XYZ at step 90B-2. Step 90B-2 may include determining the center point of a circle defined by the three points determined at step 90B-1, which may be projected on a plane parallel to the YZ plane associated with the sensor 82. The center point of the circle may be utilized as a temporary origin for the coordinate system of the sensor 82. The first reference plane REF1 may be established along the YZ plane of the tool frame TF. Step 90B may include shifting the base frame BF such that the X-axis is aligned with the center of the saw blade 38.

Step 90B may include determining the base angles A, B at step 90B-3. Step 90B-3 may include moving the tool 36 such that the saw blade 38 may intersect the field of view of the sensor 82. In implementations, a center of the saw blade 38 may be aligned with the field of view of the sensor 82. Step 90B-3 may include moving the saw blade 38 (e.g., vertically and/or horizontally) along the first reference plane REF1 (FIG. 8). Step 90B-3 may include moving the saw blade 38 downward such that the field of view of the sensor 82 intersects a bottom (e.g., 6 o'clock) position of the saw blade 38. In implementations, a laser beam emitted by the sensor 82 may be broken on a bottom edge of the saw blade 38. Step 90B-3 may be repeated for one or more iterations at different (e.g., more distant) positions from the sensor 82. Step 90B-3 may include moving the saw blade 38 from a position associated with the first reference plane REF1 to a position associated with a second reference plane REF2 (FIG. 8) to establish a different distance from the sensor 82. The determined points may be utilized to determine the base angle B. Step 90B-3 may be repeated using a side of the saw blade 38 to determine the angle A. Step 90B-3 may include moving the saw blade 38 from a position associated with the second reference plane REF2 to a position associated with a third reference plane REF3 (FIG. 9) to establish a different distance between the side of the saw blade 38 and the sensor 82.

Step 90B may include setting a true Z position at step 90B-4. Step 90B-4 may include referencing a reference feature 37 on the tool 36 to detect a rising edge of the laser or another signal of the sensor 82 to determine a true Z-value of the sensor 82 in world space. The reference feature 37 may be precisely machined or otherwise dimensioned (see also FIGS. 4-5 and 7). The dimensions of the reference feature 37 and its relationship to the flange frame FF may be known to, and may be referenced by, the controller 48. The reference feature 37 may be distinct from other features of the tool 36. In implementations, the reference feature 37 may be a flange having a having a substantially wedge-shaped geometry. In implementations, the reference feature 37 may include one or more planar faces that cooperate to establish a width, height and length of the reference feature 37. Step 90B-4 may include moving the reference feature 37 along a fourth reference plane REF4 (e.g., vertically and/or horizontally) such that reference feature 37 is positioned in a field of view of the sensor 82 (see, e.g., FIG. 9).

Step 90B may include storing the base coordinate system (e.g., frame) at step 90B-5. Base frame values for X and Y may be approximate. A frame value of C may be arbitrary. In implementations, further calculations using the frame may only rely on Z, A and B values. An origin of the base frame BF may be established along the X-axis such that the origin may be spaced apart from the sensor 82. In implementations, the sensor 82 may be a laser. The origin of the base frame BF may be aligned with a beam of the laser but may be spaced apart from an emitter of the laser. The base frame BF may be established relative to a world reference system. The world reference system may be associated with a work cell in which the robot 22 may be situated. The controller 80 may be configured to reference the world reference system. In implementations, the controller 80 may be operable to reference a position of the robot 22 in the world system. In implementations, the base frame BF may not be fully defined to calibrate a position and orientation of the saw blade 38. For example, a rotation of the base frame BF about the C-axis may be arbitrary since the origin may be established at any position along the field of view (e.g., beam) of the sensor 82 (e.g., X-axis aligned with a detection path of the beam).

Referring to FIGS. 5 and 10-11, with continuing reference to FIGS. 1 and 3-4, at step 90C the position and orientation of the saw blade 38 may be calibrated. Step 90C may include refining the nominal TCP from CAD data to match the real-world geometry. The techniques disclosed herein may provide on-the-fly calculations of TCP as the tool 36 is articulated.

Step 90C may include resetting the tool coordinate system (e.g., frame) at step 90C-1. The tool frame may be reset to a nominal value based on CAD data. The saw servo of the tool 36 may be set to approximately 90 degrees such that a first face F1 of the saw blade 38 may be substantially perpendicular to the field of view of the sensor 82.

Step 90C may include setting the A and B values of the tool frame TF at step 90C-2. Step 90C-2 may include measuring a distance from sensor 82 to point(s) on a side (e.g., front face) of the saw blade 38 (see, e.g., FIG. 5). The A value may be calculated and corrected such that the result may be a zero angle. The corrected A value may be validated and/or further corrected until the A value is zero. Step 90C-2 may be repeated for angle B. Example points are indicated at A1, A2, B1, B2 (FIG. 5) along the saw blade 38. Points A1, A2 may be utilized to establish the tool frame A values. Points B1, B2 may be utilized to establish the tool frame B values. In implementations, step 90C-2 may include moving (e.g., horizontally and/or vertically) the saw blade 38 along a fifth reference plane REF5 (FIG. 10). Step 90C-2 may occur such that saw blade 38 may substantially match the XZ plane of the tool frame TF to account for variability of the saw blade 38. The A and B values may be adjusted such that the tool frame TF may match the saw blade 38. In implementations, the XY, XZ, YZ planes may be defined prior to defining the X, Y, Z axes of the tool frame TF since adjustments to the XY, XZ, YZ planes will affect the X, Y, Z axes, but not vice versa. In the implementation of FIGS. 13-14, step 90C-2 may include moving a tool 136 such as a saw blade 138 relative to a sensor 182 of the calibration system 178. Step 90C-2 may include determining any of the points and/or distances disclosed herein in response to establishing contact between the tool 136 and a probe 185 of the sensor 182. A controller 180 of the calibration system 178 may be operable to determine the point(s) and/or distance(s) based on a relative change in position and/or orientation between the tool 136 and sensor 182. Step 90C-2 may include moving the tool 136 away from the probe 185, translating the tool 136 to a point opposite the center of the saw blade 138 and then moving the tool 136 toward the probe 185 to reestablish contact between the tool 136 and the probe 185.

Step 90C may include setting tool frame Z values at step 90C-3. Step 90C-3 may include moving the saw blade 38 within the field of view of the sensor 82 (FIG. 10). In implementations, this may include breaking a laser beam on the bottom center of the saw blade 38. The tool frame Z values may be calculated using this position. In implementations, step 90C-3 may include moving (e.g., horizontally and/or vertically) the saw blade 38 along the fifth reference plane REF5 (FIG. 10).

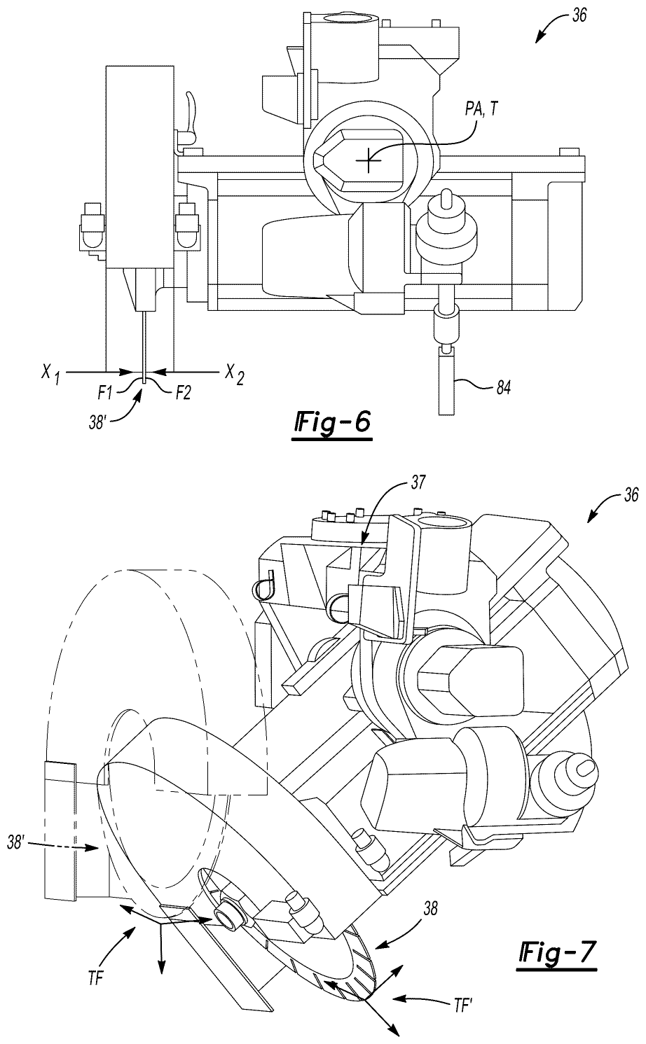

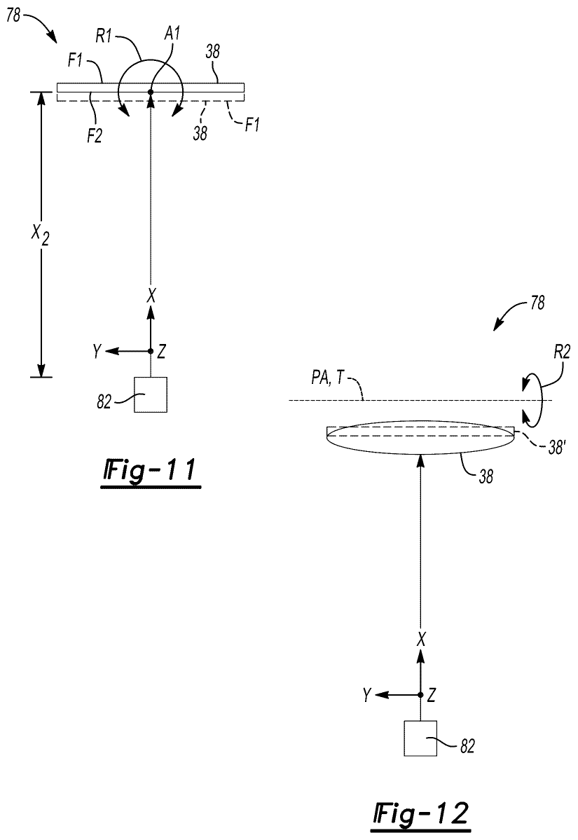

Referring to FIG. 6, with continuing reference to FIGS. 1 and 3-5, step 90C may include setting the tool frame X value at step 90C-4. Step 90C-4 may include measuring a distance (e.g., X₁) between the sensor 82 and the first face F1 of the saw face at the bottom center of the saw blade 38 (FIG. 10). The saw blade 38 may be rotated approximately 180 degrees to a distance (e.g., X₂) between the sensor 82 and a second face F2 on the opposite side of the saw blade 38. In implementations, the saw blade 39 may be rotated approximately 180 degrees in the rotational direction R1 about the axis A1 such that the second face F2 may be presented to the field of view of the sensor 82 (FIG. 11). A difference may be calculated between these two measurements (e.g., X₁, X₂). The difference may correspond to a calibration offset between the TCP of the saw blade 39 (e.g., tool frame TF) and the center of the saw blade 39. The X value of the tool frame TF may be offset by half of the difference. The distances may be validated and/or adjusted until the two measurements are substantially equal. In the implementation of FIGS. 13-14, step 90C-4 may include moving the tool 136 relative to the sensor 182 of the calibration system 178. Step 90C-4 may include moving the tool 136 away from the probe 185, rotating the tool 136 about an axis (e.g., approximately 180 degrees in the direction R1 about the axis A1 of FIG. 11) and then moving the tool 136 toward the probe 185 to reestablish contact between the tool 136 and the probe 185. The X value of the tool frame TF may be determined based on an amount of movement to reestablish contact between the tool 136 and probe 185.

Step 90C may include storing a 90-degree tool frame at step 90C-5. The C and Y values may be arbitrary (e.g., near nominal).

Step 90C may include calculating the tool frame at another (e.g., preselected) angle (e.g., 45 degrees) at step 90C-6. Step 90C-6 may include setting the saw servo of the tool 36 to another angle (e.g., 45 degrees) and then repeating steps 90C-2 to 90C-5. In the implementation of FIGS. 13-14, the angle may be set based on a configuration of the tool 136 and/or probe 182.

Referring to FIGS. 7 and 12, with continuing reference to FIGS. 1 and 3-6 and 10-11, step 90C may include calculating a pivot axis PA at step 90C-7. In implementations, the pivot axis PA may be associated with the tool axis T (FIGS. 1 and 6). Step 90C-7 may include using the calculated TCP at 90 degrees and/or at 45 degrees to calculate a best-fit (e.g., three-dimensional) pivot axis PA through which the saw blade 38 may rotate. The pivot axis PA may be normalized and stored as a frame. Saw blade 38′ is disclosed at an orientation prior to or subsequent to rotation about the pivot axis PA. Step 90C may include rotating the tool 36, including the saw blade 38, in a rotational direction R2 about pivot axis PA at a predetermined angle (FIG. 12). The predetermined angle may be approximately 45 degrees. In implementations, step 90C-7 may include pivoting the tool frame TF about the pivot axis PA to establish a tool frame TF′ (FIG. 7). Step 90C may include calculating any TCP at step 90C-7. For any angle within the range of the saw blade 38, the true TCP may be calculated by calculating the geometric transform from the calculated pivot point (e.g., “Delta”) to the stored 90-degree TCP. The pivot point may be a vector in 3D space associated with the pivot axis PA. A specified rotation may be applied to the pivot before reapplying the Delta to the new rotated pivot. The resulting frame may establish the new TCP.

The tool frame TF may be established such that an origin of the tool frame TF may be defined relative to the saw blade 38. In the implementation of FIG. 2, the origin of the tool frame TF may be established at approximately a 6 o'clock position of the saw blade 38 along the first face F1 of the saw blade 38.

Step 90C may include updating the TCP at step 90C-9. Step 90C-9 may include performing any of steps 90C-1 to 90C-8. Step 90C-9 may be utilized to account for any wear of the saw blade 38 due to performing one or more cutting operations.

At step 90D a position and orientation of the fluid jet cutter 40 may be calibrated. Any of steps 90C-1 to 90C-8 may be utilized to perform step 90D. In implementations step 90C-2, tool B and C values associated with the fluid jet cutter 40 may be established based on the calibration tool 84. The calibration tool 84 may provide substantially flat surface(s) for the sensor 82 to measure. Step 90C-4 may be performed to determine the X and Y values associated with the fluid jet cutter 40.

FIGS. 13-14 disclose another implementation of a calibration system 178. The calibration system 178 may be incorporated into a (e.g., robotic or gantry) system 120, such as the system 20 (e.g., FIG. 1). In this disclosure, like reference numerals designate like elements where appropriate and reference numerals with the addition of one-hundred or multiples thereof designate modified elements that are understood to incorporate the same features and benefits of the corresponding original elements. The calibration system 178 may include one or more end of arm tools (EOAT) 136. The tool(s) 136 may be positionable (e.g., moveable) relative to one or more sensors 182. Various end of arm tools may be utilized, including any of the tools disclosed herein. The tools 136 may include various cutting tools such as saw blade(s) 138 and/or fluid jet cutter(s) 140.

Various sensors may be utilized to perform the calibration, including one or more (e.g., touch) probes 185. In implementations, the probe 185 may include a limit switch. The probe 185 may be operable to measure a surface (e.g., face) of the tool 136. The controller 180 may be operable to cause the device 122 to move the tool 136 and the probe 185 relative to each other. In implementations, a housing of sensor 182 may be stationary relative to a base of the automated system (e.g., base 24 of FIG. 1). The controller 180 may be operable to cause the device 122 to move the tool 136 along one or more (e.g., predefined) paths such that the probe 185 contacts one or more surface(s) (e.g., faces) of the tool 136 associated with respective positions of the tool 136. In implementations, the controller 180 may be operable to align the X-axis of the base frame BF with a detection path (e.g., field of view) of the sensor 182. The path may be associated with a path of articulation of the probe 185 and/or another portion of the sensor 182. The controller 180 may be operable to cause the device 122 to move the tool 136 in a direction D1 such that the probe 185 contacts a surface of the tool 136, such as a respective face of the saw blade, to actuate the probe 185 (FIG. 14).

The calibrated techniques disclosed herein may be utilized to determine a position and orientation of tools for performing highly accurately cutting and other operations on workpieces. The calibration techniques disclosed herein may be utilized to determine a tool center point (TCP) associated with a tool without manual intervention.

The calibration technique may be established by performing a limited set of motions. The calibration system may move a tool within a plane to determine a first set of points along the tool relative to a sensor. The system may move the tool away or towards the sensor to establish a different distance from the sensor. The tool may be rotated about an axis (e.g., approximately 180 degrees) to determine a second set of points along the tool relative to the sensor. The system may move the tool away or towards the sensor to establish a different distance from the sensor. The tool may be pivoted to another plane (e.g., from approximately 90 degrees to approximately 45 degrees) to determine the first and second set of points along the tool relative to the sensor and the different distances relative to the sensor.

The disclosed techniques may accommodate various end of arm tools (EOAT) having different geometries that may be mounted to the robot. The disclosed techniques may be used to articulate tools having different geometries by establishing a dynamic coordinate system that may move with the respective tool. The coordinate system established for the tool may be fixed for a given robot task to provide highly accurate operations.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should further be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed:

1. A calibration system comprising:
a sensor operable to determine a position of a tool relative to the sensor; and
a controller coupled to the sensor, wherein the controller is operable to:
cause the tool to move along a path defined by a first predefined pattern and a second defined pattern relative to the sensor;
define, using the sensor, a base frame associated with the sensor based on movement of the tool associated with the first predefined pattern;
define, using the sensor, a tool frame associated with the tool based on movement of the tool associated with the second predefined pattern; and
determine a tool center point associated with the tool frame of the tool.

2. The system as recited in claim 1, wherein the controller is operable to:
align an axis of the base frame with a detection path associated with the sensor.

3. The system as recited in claim 1, wherein the controller is operable to:
define, using the sensor, the tool frame in response to determining a first set of positions along a first side of the tool relative to the sensor.

4. The system as recited in claim 3, wherein the controller is operable to:
determine, using the sensor, the first set of positions in response causing the tool to move along a first reference plane that is transverse to a detection path of the sensor.

5. The system as recited in claim 3, wherein the controller is operable to:
determine, using the sensor, a calibration offset relative to a center of the tool in response to causing the tool to rotate about a first axis.

6. The system as recited in claim 3, wherein the controller is operable to:
cause the first side of the tool to face towards the sensor;
determine, using the sensor, the first set of positions;
cause a second side of the tool to face towards the sensor, the second side opposite the first side;
determine, using the sensor, a second set of positions along the second side of the tool; and
determine the tool center point based on the determined first set of positions and the determined second set of positions.

7. The system as recited in claim 3, wherein the controller is operable to:
cause the tool to pivot from a first orientation to a second orientation; and
define, using the sensor, the tool frame in response to causing the tool in the second orientation to repeat movement corresponding to a portion of the second predefined pattern associated with the first orientation.

8. The system as recited in claim 1, wherein the tool includes a saw blade.

9. The system as recited in claim 1, wherein the tool includes a fluid jet cutter.

10. The system as recited in claim 1, wherein the tool includes a calibration tool representative of another tool.

11. The system as recited in claim 1, wherein the sensor is a laser or a touch probe.

12. An automated system comprising:
an automated device;
a tool secured to the automated device at an interface, wherein the automated device is operable to move the tool relative to a workpiece; and
a calibration assembly comprising:
a sensor operable to determine a position of the tool relative to the sensor; and
a controller coupled to the sensor, wherein the controller is operable to:
define, using the sensor, a base frame associated with the sensor based on movement of the tool associated with a first predefined pattern;
define, using the sensor, a tool frame associated with the tool based on movement of the tool associated with a second predefined pattern;
determining a tool center point of the tool based on the tool frame; and
determine a position and/or orientation of the tool relative to the base frame.

13. The system as recited in claim 12, wherein the controller is operable to:
align an axis of the base frame with a detection path of the sensor.

14. The system as recited in claim 12, wherein the controller is operable to:
determine, using the sensor, a calibration offset relative to a center of the tool in response to causing the tool to rotate about a first axis; and
determine the tool frame based on the determined calibration offset.

15. The system as recited in claim 12, wherein the controller is operable to:
cause the tool to pivot from a first orientation to a second orientation; and
define, using the sensor, the tool frame in response to causing the tool in the second orientation to repeat movement associated with a portion of the second predefined pattern associated with the first orientation.

16. A method of calibrating an automated device comprising:
securing a tool to an automated device;
positioning the tool relative to a sensor;
moving the tool based on a first predefined pattern and a second predefined pattern;
defining, using the sensor, a base frame associated with the sensor in response to moving the tool based the first predefined pattern;
defining, using the sensor, a tool frame associated with the tool in response to moving the tool based the second predefined pattern;
determining a tool center point of the tool based on the tool frame; and
determining a position and/or orientation of the tool relative to the base frame.

17. The method as recited in claim 16, wherein:
the step of defining the base frame includes aligning an axis of the base frame with a detection path of the sensor.

18. The method as recited in claim 16, wherein:
the step of determining the tool frame includes rotating the tool from a first position to a second position, a first side of the tool faces the sensor in the first position, a second side of the tool faces the sensor in the second position, and the second side is opposite the first side.

19. The method as recited in claim 16, wherein:
the step of moving the tool based on the second predefined pattern includes pivoting the tool from a first orientation to a second orientation, and then repeating a portion of the second predefined pattern associated with the first orientation.

20. The method as recited in claim 16, wherein the tool is a saw blade.
